(19) United States
(12) Patent Application Publication
(10) Pub. No.: US 2015/0361516 A1
(43) Pub. Date: Dec. 17, 2015

(54) METHOD OF HEAT TREATING METAL ARTICLES AND METAL ARTICLE TREATED THEREBY

(71) Applicant: TOYOTA JIDOSHA KABUSHIKI KAISHA, Toyota-shi, Aichi (JP)

(72) Inventors: Koji INAGAKI, Toyota-shi (JP); Takaaki KANAZAWA, Toyota-shi (JP)

(73) Assignee: TOYOTA JIDOSHA KABUSHIKI KAISHA, Toyota-shi, Aichi (JP)

(21) Appl. No.: 14/763,365

(22) PCT Filed: Jan. 25, 2013
(86) PCT No.: PCT/JP2013/051570

§ 371 Date: Jul. 24, 2015

(51) Int. Cl. C21D 1/18; C21D 7/08; F16H 55/36; C22C 38/00; C21D 9/32; C21D 6/00; C21D 7/06; B24C 1/08

(52) U.S. Cl. CPC C21D 1/18; C21D 7/06; C21D 7/08; B24C 1/08; C22C 38/00; C21D 9/32; C21D 6/00; F16H 55/36

(57) ABSTRACT

A method of heat treating metal articles includes a heating process of heating a metal workpiece under a predetermined heating condition, a cooling process of cooling the workpiece by spraying mist of cooling water to the workpiece under a predetermined cooling condition after heating the workpiece, and a surface treatment process of adjusting a surface roughness of the workpiece prior to the heating process in line with a thermal distribution in the workpiece heated during the heating process.

### TECHNICAL FIELD

The present invention relates to a method of heat treating metal articles by rapidly cooling a heated metal article by cooling mist, and to the metal article treated thereby.

### BACKGROUND ART

In recent years, a mist cooling of heated metallic workpiece has been in practice during the heat treatment to improve cooling effect of the workpiece utilizing sensible heat transfer and latent heat of vaporization resulting from applying the cooling mist to the workpiece.

An example of the mist cooling of the heated metal workpiece is described in Japanese Patent Laid-Open No. 2011-122211. The mist cooling apparatus taught by Japanese Patent Laid-Open No. 2011-122211 includes a first nozzle and a second nozzle to spray cooling mist to a heat treated subject, and a particle diameter of the second nozzle is smaller than that of the first nozzle.

According to the teachings of Japanese Patent Laid-Open No. 2011-122211, the particle diameter of the cooling mist which is sprayed from the first nozzle is larger than the particle diameter of the cooling mist which is sprayed from the second nozzle. Therefore, the amount of latent heat of vaporization for each particle of the cooling mist of the first nozzle is larger than that of the cooling mist of the second nozzle. For this reason, it is possible to cool the treated subject of the heat treatment at a wide range of cooling speeds. Further, the rapid cooling may be performed during a certain period, and the gentle cooling may be performed with the uniformity of cooling during the other period so as to prevent deformation or warpage of the treated subject.

Thus, the cooling effect can be improved by the mist cooling, and a cooling speed can be controlled by adjusting a spraying amount and time. The mist cooling can be performed more properly in accordance with dimensions and configuration of the workpiece by using nozzles having different diameters as taught by Japanese Patent Laid-Open No. 2011-122211, while adjusting numbers, positions, spraying angles and spraying pressures of the nozzles to control the cooling speed.

However, it is not easy to cool all kinds of the workpieces having different dimensions and configurations homogeneously and properly by the mist cooling. For example, it is necessary to adjust positions, angles and pressures of the nozzles shown in FIG. 10 to homogeneously cool a workpiece having a configuration and thermal distribution shown in FIG. 9. Nonetheless, those nozzles have to be readjusted to conform to another kind of workpiece having a different configuration. In fact, it is difficult to effectively cool all kinds of the workpieces having different configurations.

### DISCLOSURE OF THE INVENTION

The present invention has been conceived noting the foregoing technical problem, and it is therefore an object of the present invention is to provide a method of heat treating metal articles that can homogeneously and effectively quenching or cooling heated metal article of different configurations by spraying mist thereto while adjusting a cooling rate in accordance with a configuration of the article, and to provide a metal article treated by this method.

According to one aspect of the present invention, there is provided a method of heat treating metal articles comprised of: a heating process of heating a metal workpiece under a predetermined heating condition; and a cooling process of cooling the workpiece by spraying mist of cooling water to the workpiece under a predetermined cooling condition after heating the workpiece. In order to achieve the above-explained objectives, according to the present invention, a surface treatment process is carried out to adjust a surface roughness of the workpiece prior to the heating process in line with a thermal distribution in the workpiece heated during the heating process.

According to the present invention, the surface treatment process includes a process of reducing the surface roughness of a portion of the workpiece to which a large quantity of heat is distributed.

In the cooling process, an average diameter of the mist sprayed to the workpiece is adjusted within a range from 0.1 mm to 2.0 mm.

For example, the workpiece may be a steel part of automobiles.

Specifically, the workpiece is a steel member of a pulley used in a belt-driven continuously variable transmission.

The surface treatment process includes a process of machining the workpiece.

Specifically, the surface treatment process of the workpiece includes at least any of a shot-peening, a shot-blasting, a sand-blasting, a grinding and a polishing.

According to another aspect of the present invention, there is provided a heat treated metal article, that is heated under a predetermined heating condition, and then cooled by spraying mist of cooling water thereto under a predetermined cooling condition. In order to achieve the above-explained objectives, according to the present invention, a surface roughness of the metal article is adjusted in line with a thermal distribution in the metal article heated under a predetermined cooling condition, and thereafter the metal article is subjected to a heat treatment.

According to the present invention, the surface roughness of the metal article is reduced at a portion to which a large quantity of heat is distributed.

For example, the metal article may be a steel part of automobiles.

Specifically, the metal article is a steel member of a pulley used in a belt-driven continuously variable transmission.

Thus, according to the heat treating method of the present invention, the surface roughness of the workpiece is adjusted during the surface treatment process in accordance with the thermal distribution in the workpiece heated during the heating process, prior to the heating process and the mist cooling process under the predetermined conditions. Specifically, the surface roughness of a portion of the workpiece to which a large quantity of heat is distributed is reduced to be finer. During cooling the workpiece heated to be hotter than a boiling point of water by spraying the mist of the cooling water thereto, as shown in FIG. 11, a cooling time or rate of the workpiece is shortened by reducing the surface roughness thereof.

That is, according to the heat treating method of the present invention, the cooling rate of the workpiece can be optimized by thus adjusting the surface roughness of the workpiece to be heated. As described, the surface roughness of the portion of the workpiece to which a large quantity of heat is distributed is reduced to be relatively finer to be cooled by the mist relatively faster. By contrast, the surface roughness of the portion of the workpiece to which a small quantity of heat is distributed is increased to be relatively rougher to be cooled by the mist relatively slower. Thus, the cooling rate of the workpiece can be adjusted by adjusting the surface roughness thereof in accordance with the thermal distribution in the workpiece during the surface treatment process before the heat treatment. For this reason, the cooling rate of the workpiece can be optimized without altering the positions, the number, and the spraying condition of the nozzles. Therefore, even if a size or configuration of the workpiece is altered, the workpiece can be cooled easily and homogeneously by mist without altering the setting of the cooling facility. In addition, deformation of the workpiece can be reduced by thus cooling the workpiece homogeneously. For this reason, the finishing work of the workpiece can be omitted or simplified so that a cost for manufacturing the workpiece can be reduced.

As described, the surface roughness of the workpiece may be adjusted easily by machining such as lathing or milling. Alternatively, the surface roughness of the workpiece may also be adjusted by the shot-peening, the shot-blasting, the sand-blasting, the grinding and the polishing.

According to another aspect of the present invention, the surface roughness of the metal article is adjusted in accordance with the thermal distribution in the metal article heated during the heating process, and then the heat treatment is applied to the metal article. As described with reference to FIG. 11, the cooling time of the heated metal article during the mist cooling can be shortened by reducing the surface roughness thereof. Specifically, the surface roughness of the portion of the metal article to which a large quantity of heat is distributed is reduced to be relatively finer to be cooled by the mist relatively faster. By contrast, the surface roughness of the portion of the metal article to which a small quantity of heat is distributed is increased to be relatively rougher to be cooled by the mist relatively slower.

Thus, the cooling rate of the heated metal article can be adjusted by adjusting the surface roughness thereof in accordance with the thermal distribution in the therein before the heating. For this reason, the cooling rate of the metal article can be optimized without altering the positions, the number, and the spraying condition of the nozzles so that the workpiece can be cooled easily and homogeneously. In addition, deformation of the metal article can be reduced by thus cooling the workpiece homogeneously. For this reason, the finishing work of the metal article can be omitted or simplified so that a cost for manufacturing the metal article can be reduced.

### BRIEF DESCRIPTION OF THE DRAWINGS

FIG. 1 is a schematic illustration showing one example of a metal article treated by the method according to the present invention.

FIG. 2 is a process chart showing one example of heat treating a workpiece while adjusting a surface roughness by the method according to the present invention.

FIG. 3 is a schematic illustration showing one example of a cooling arrangement used to mist cooling the metal article by the method according to the present invention.

FIG. 4 is a graph indicating variations in a cooling rate at each point of the workpiece cooled by the mist cooling according to the method of the present invention.

FIG. 5 is a graph indicating variations in a cooling rate at each point of the workpiece cooled by the mist cooling without applying the method of the present invention.

FIG. 6 is a graph indicating a comparison between the cooling rates shown in FIGS. 4 and 5.

FIG. 7 is a graph indicating a comparison between a deformation of the workpiece cooled by the method of the present invention and a deformation of the workpiece cooled without carrying out the method of the present invention.

FIG. 8 is a graph indicating a comparison between a cost of the workpiece manufactured by the method of the present invention and a cost of the workpiece manufactured by a method other than the present invention.

FIG. 9 is a schematic illustration showing thermal distribution in the heated metal article treated by the method according to the present invention.

FIG. 10 is a schematic illustration showing an example of a cooling arrangement to mist cooling the metal article shown in FIG. 9 by a conventional method.

FIG. 11 is a graph indicating a relation between the surface roughness and the cooling rate of the metal article cooled by mist.

### DETAILED DESCRIPTION OF THE PREFERRED EMBODIMENT(S)

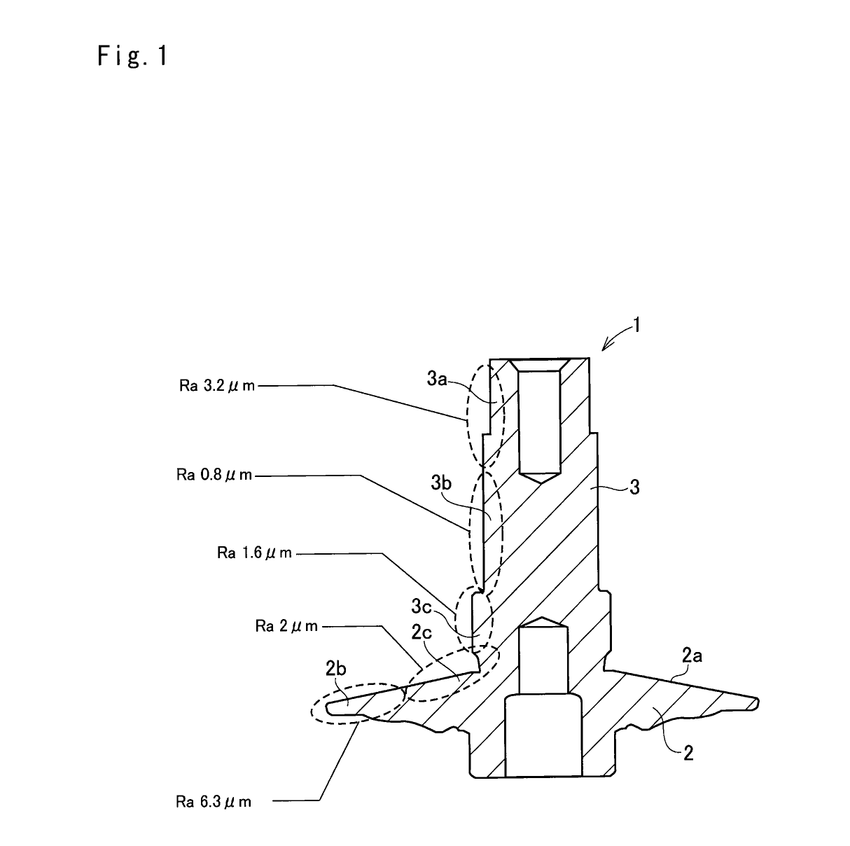

Next, the present invention will be explained in more detail with reference to the accompanying drawings. Referring now to FIG. 1, there is shown an example of a workpiece 1 as a metal article to be treated by the method of the present invention. Specifically, the workpiece 1 shown in FIG. 1 is a fixed sheave of a pulley of a belt-driven continuously variable transmission made of steel that is used in automobiles. The workpiece 1 is comprised of a fixed sheave 2, a shaft 3 formed integrally therewith to serve as a pulley shaft, and a conical surface 2a formed on the fixed sheave 2 to be opposed to a conical surface of a (not shown) movable sheave to form a groove for holding a (not shown) drive belt. The shaft 3 of the workpiece 1 is slidably inserted into the movable sheave to form the pulley of the belt-driven continuously variable transmission.

The workpiece 1 is subjected to a machine processing such as a forging, a lathing, a counter boring etc. to be shaped into the configuration shown in FIG. 1. For example, the fixed sheave 2 and the shaft 3 are forged integrally, and then turned into a desired detentions and configuration. In order to form a joint portion, a fixing portion, a lubrication passage etc., a counter boring is applied to a center of the shaft 3.

The workpiece 1 is heated while being carburized, nitrided, or carburized-nitrided, and then cooled under a predetermined condition. According to the preferred example, a mist cooling is employed to quench or cool the heated workpiece 1 by spraying cooling water thereto during the heat treatment.

The method of the present invention may be applied to all kinds of metal articles to be cooled by mist. For example, the method of the present invention may also be applied to non-ferrous metal articles such as a cast-iron article, and an aluminum alloy article, other than the steel made metal workpiece shown in FIG. 1.

In order to cool the workpiece 1 entirely homogeneously by the mist cooling, a surface roughness of the workpiece 1 is adjusted in accordance with a thermal distribution in the heated workpiece 1 to optimize a cooling rate at each portion of the workpiece 1. To this end, a surface of the workpiece 1 is processed in such a manner that a surface roughness of a portion to which a large quantity of heat is distributed is reduced to be finer the remaining portion.

The outer surface of the workpiece 1 is turned by a lathe in accordance with a thermal distribution in the heated workpiece 1 prior to applying the heat treatment thereto. For example, a flat surface of the workpiece 1 may be turned to achieve a desired roughness by a milling machine. Alternatively, the flat surface of the workpiece 1 may also be processed to achieve a desired roughness by a shot-peening, a shot-blasting, a sand-blasting, a grinding, a polishing and so on.

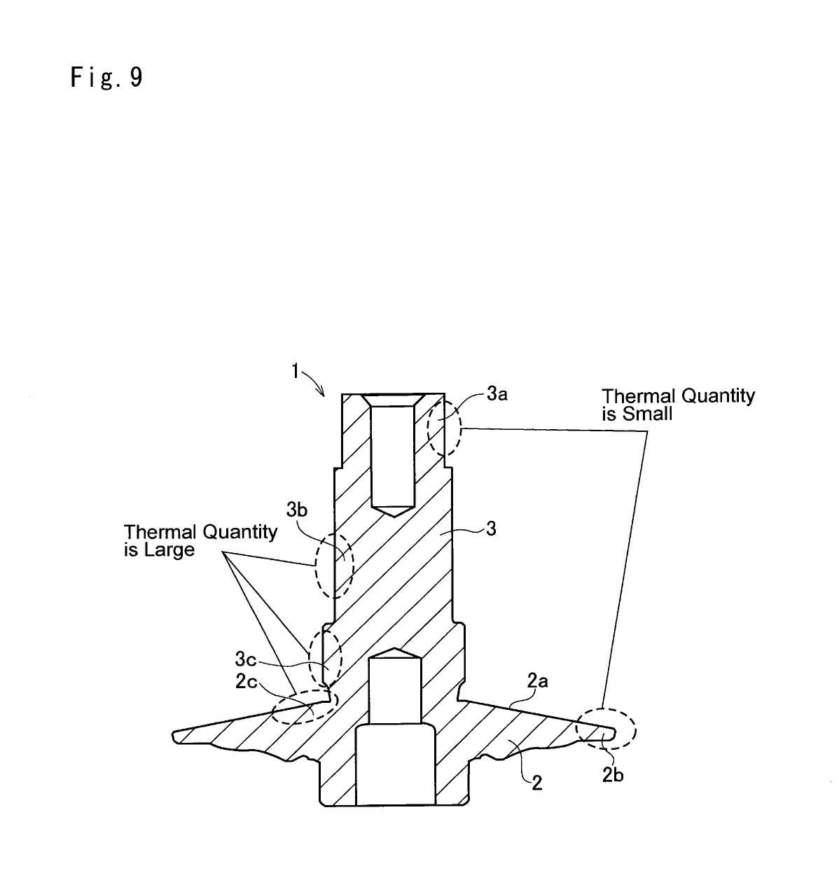

The thermal distribution in the heated workpiece 1 is shown in FIG. 9. Specifically, in the heated workpiece 1, a relatively large quantity of heat is distributed to a diametrically large intermediate portion 3b of the shaft 3, a junction 2c of the fixed sheave 2, and a junction 3c of the shaft 3. Such thermal distribution in the heated workpiece 1 may not only be measured by sensors but also estimated by a simulation using a computer.

A surface roughness of each point of the workpiece 1 is individually adjusted in line with the above-explained thermal distribution therein. Specifically, the surface roughness of the junctions 2c and 3c, and the intermediate portion 3b is respectively reduced to be relatively finer. By contrast, the surface roughness of portions to which a relatively small amount of heat is distributed such as an outer circumferential edge 2b and a leading end 3a is respectively increased to be relatively rougher. In the example shown in FIG. 1, specifically, an average surface roughness Ra of the intermediate portion 3b is adjusted to a target value of 0.8 μm, an average surface roughness Ra of the junction 3c is adjusted to a target value of 1.6 μm, and an average surface roughness Ra of the junction 2c is adjusted to a target value of 2.0 μm. By contrast, an average surface roughness Ra of the leading end 3a is adjusted to a target value of 3.2 μm, and an average surface roughness Ra of the outer circumferential edge 2b is adjusted to a target value of 6.3 μm.

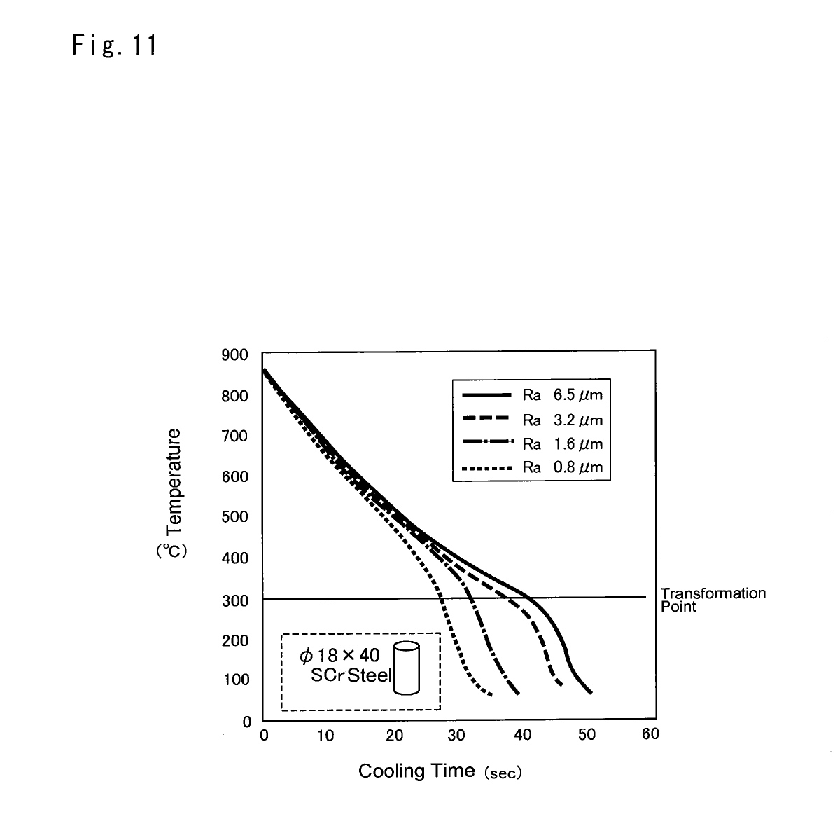

The surface roughness of the metal workpiece 1 is adjusted prior to be heated in such a manner that the average roughness of each portion conforms respectively to the thermal distribution therein. Specifically, the surface roughness of the portion at which a large quantity of heat is distributed is reduced to be relatively finer. As explained with reference to FIG. 11, the heated metal article can be cooled faster by the mist by reducing the surface roughness thereof. That is, the cooling rate of the metal article per unit of time can be increased. Specifically, FIG. 11 shows a measurement result of cooldown time of a heated test piece of chrome steel by mist, and a surface roughness of the test piece was adjusted in the above-explained manner. In the measurement shown in FIG. 11, an average diameter of the mist sprayed to the test piece was adjusted within a range from 0.1 mm to 2.0 mm.

Thus, the surface roughness of the metal workpiece 1 is adjusted in such a manner that the cooling rate of the portion to which a large quantity of heat is distributed is increased to be cooled faster by mist so that the heated workpiece 1 can be cooled entirely homogeneously. For this reason, the heated workpiece 1 can be cooled without deformation.

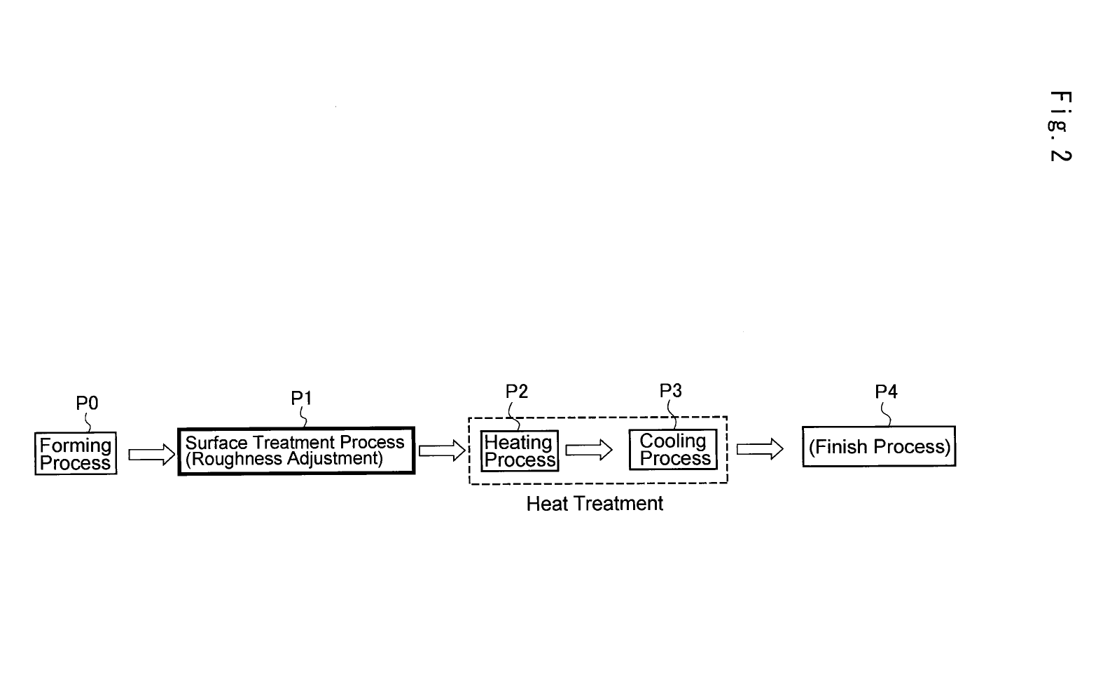

Next, the heat treating method of the metal article, that is, the method of carburizing the steel workpiece 1 will be explained hereinafter. According to the preferred example, the workpiece 1 is heated and then cooled by mist during the quenching treatment. In addition, the surface roughness of the workpiece 1 is adjusted in line with the thermal distribution therein prior to the heating process and the cooling process. Specifically, as shown in FIG. 2, the heat treating method according to the preferred example comprises a forming process (P0), a surface treatment process (P1), a heating process (P2), a cooling (or quenching) process (P3), and a finishing process (P4).

First of all, at the forming process (P0), a forging of steel material is carried out to form the workpiece 1, and then crude processing such as a burring and a lathing of the workpiece 1 are carried out. Alternatively, the burring and the lathing may also be carried out at the below-mentioned surface treatment process (P1).

At the surface treatment process (P1), the surface roughness of the workpiece 1 is adjusted in line with the thermal distribution therein. As described, the thermal distribution in the heated workpiece 1 may be measured by the sensors or estimated by a simulation using a computer. The surface roughness of each portion of the workpiece 1 is respectively adjusted to the above-explained target values based on data about the thermal distribution in the heated workpiece 1. Specifically, the surface of the workpiece 1 is processed in such a manner that the surface roughness of the portion to which a large quantity of heat is distributed is reduced to be finer than the remaining portions as shown in FIGS. 1 and 9.

As described, the heated workpiece can be cooled rapidly by the mist by reducing the surface roughness thereof as shown in FIG. 11 to promote the Leidenfrost effect. Specifically, the Leidenfrost effect is a physical phenomenon in which a liquid in contact with a mass hotter than the boiling point thereof forms an insulating vapor layer preventing the liquid from boiling rapidly, and in this case, the Leidenfrost effect can be promoted by reducing the surface roughness of the metal workpiece 1 to reduce hydrophilicity thereof. Consequently, the mist of the cooling water is allowed to remain on the surface of the workpiece 1 in longer period of time so that the surface of the workpiece 1 can be cooled effectively.

Thus, at the surface treatment process, the surface roughness of the portion of the workpiece 1 to which a large quantity of heat is distributed is reduced to be relatively finer to be cooled by the mist relatively faster. By contrast, the surface roughness of the portion of the workpiece 1 to which a small quantity of heat is distributed is increased to be relatively rougher to be cooled by the mist relatively slower.

Then, at the heating process (P2), the workpiece 1 is heated to be carburized under a predetermined gas atmosphere for a predetermined period of time. For example, the workpiece 1 is heated at 900 to 950 degrees C. under a carburizing gas atmosphere produced by propane gas or methane gas.

At the cooling (or quenching) process (P3), the carburized workpiece 1 is cooled. Although a gas cooling is widely employed in the conventional art to cool the carburized metal article, the mist cooling is employed in the heat treating method of the preferred example. As described, although the cooling effect of the mist cooling is higher than that of the gas cooling, it is difficult to adjust the nozzles to conform to all kinds of the workpieces having different configurations. In order to cool the workpiece 1 entirely homogeneously by mist, according to the preferred example, the surface roughness of each portion of the workpiece 1 is individually adjusted during the surface treatment process in such a manner that the cooling rate of each portion of the workpiece 1 are optimized.

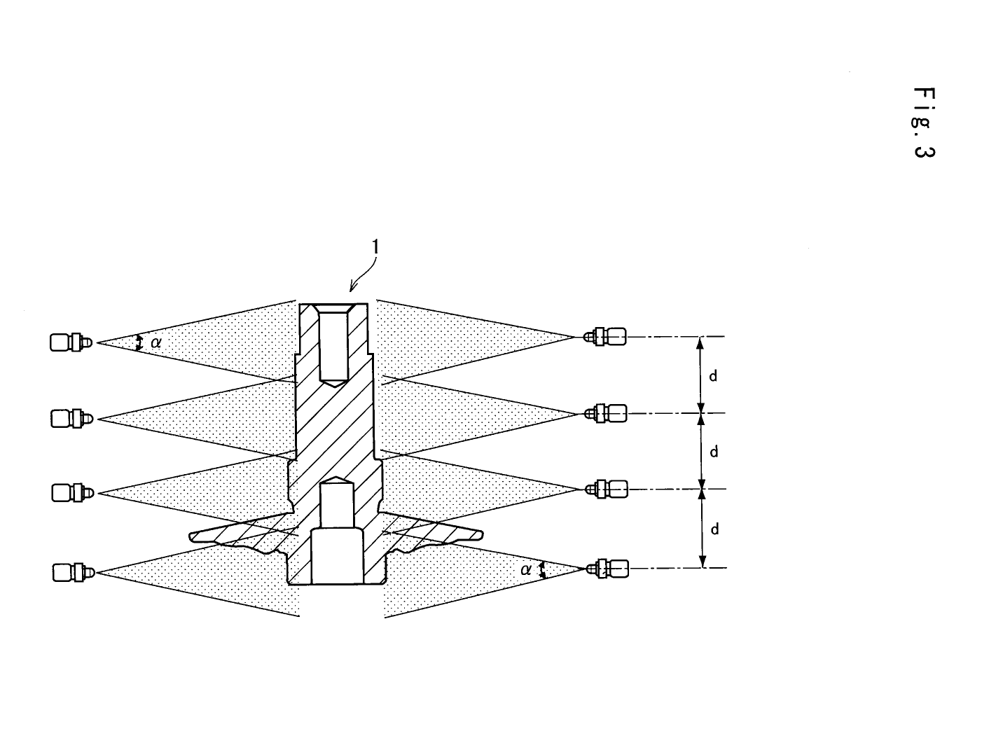

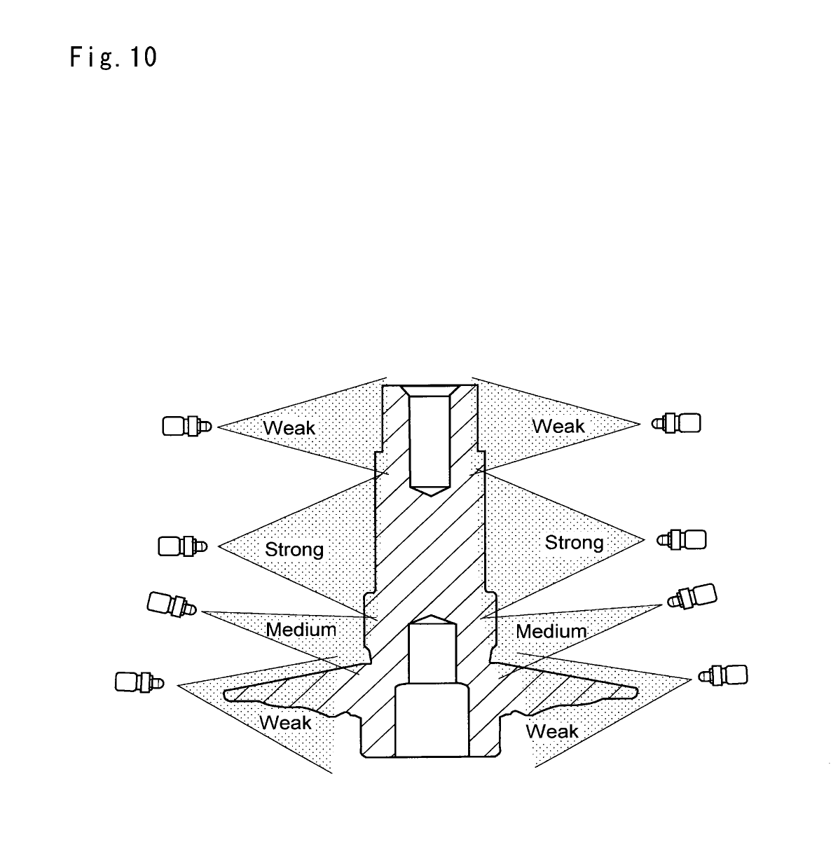

Thus, according to the heat treating method of the present invention, the cooling rate of the workpiece 1 during the cooling process can be controlled by merely adjusting the surface roughness of the workpiece 1 without changing the setting of the cooling facility. As mentioned with reference to FIG. 10, according to the conventional art, setting of the cooling facility has to be readjusted to control the cooling rate of the workpiece. By contrast, according to the heat treating method of the present invention, the setting of the nozzles does not have to be changed from that shown in FIG. 3. In addition, it is not necessary to change a spraying rate and pressure of the cooling mist.

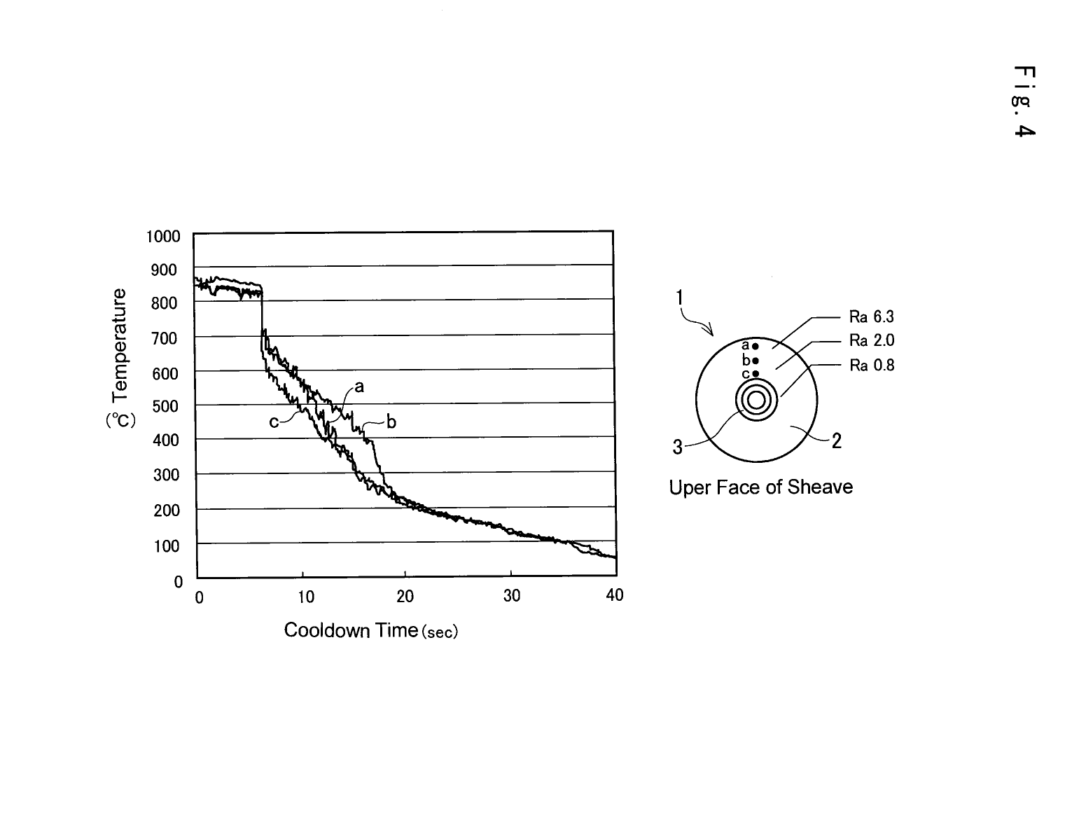

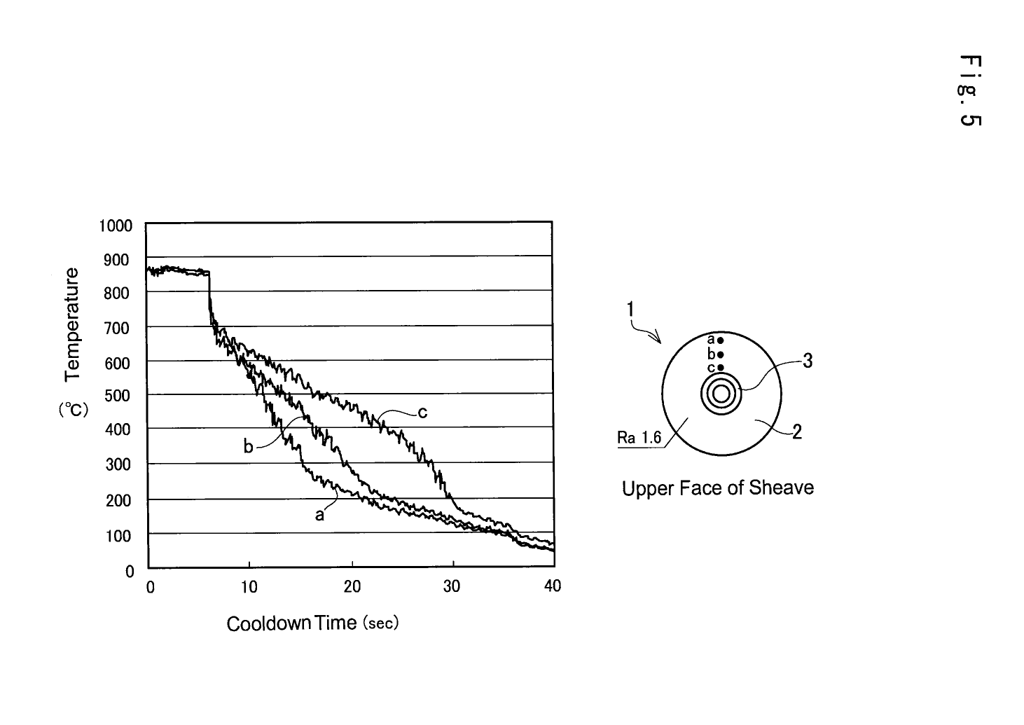

Turning now to FIG. 4, there is shown a measurement result of the cooldown time of each portion of the workpiece 1 in which the surface roughness thereof is adjusted in the above-mentioned manner. Meanwhile, FIG. 5 shows a comparison of the cooldown time of each portion of the workpiece 1 in which the surface roughness thereof is not adjusted. According to the comparison shown in FIG. 5, the cooling rate of the workpiece 1 in which the surface roughness thereof is not adjusted is relatively faster at a measurement point “a” (of the outer circumferential edge of the fixed sheave 2) and at a measurement point “b” (of an intermediate portion of the fixed sheave 2), but relatively slower at a measurement point “c” (of a circumferentially inner most portion of the fixed sheave 2). Thus, the cooling rate of each portion of the workpiece 1 varies widely in this case.

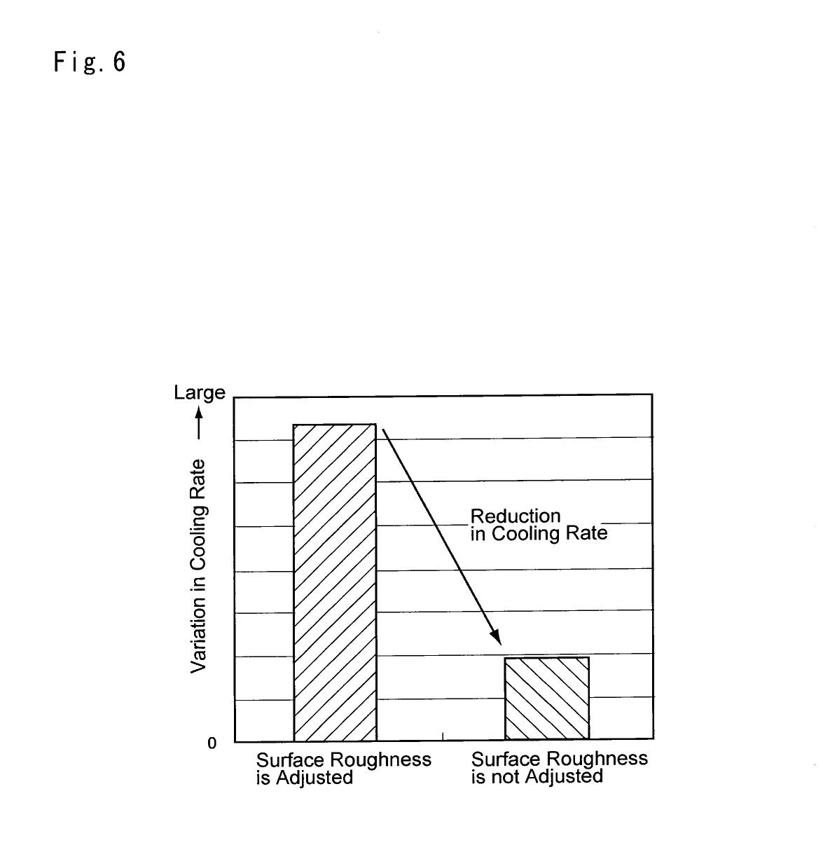

By contrast, according to the heat treating method of the preferred example, the cooling rate of the workpiece 1 does not vary significantly among each measurement point a, b and c as shown in FIG. 4. Thus, as indicated in FIG. 6, positional variation of the cooling rate of the workpiece 1 cooled by mist can be reduced significantly by adjusting the surface roughness of the workpiece 1, in comparison with that of the case in which the surface roughness of the workpiece 1 is not adjusted.

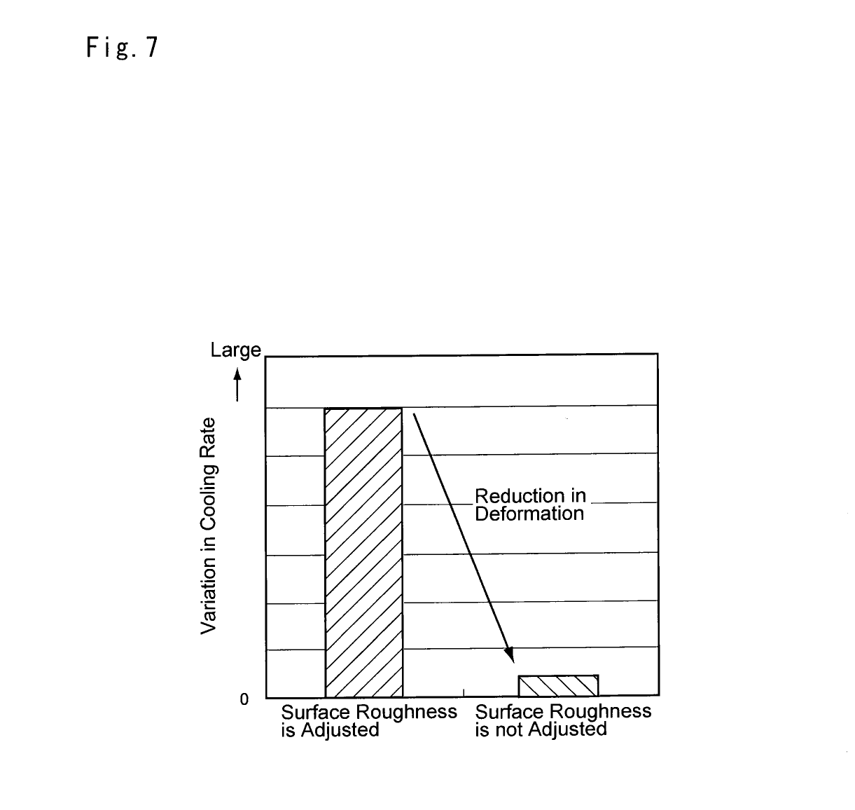

Thus, according to the heat treating method of the preferred example, the surface roughness of the workpiece 1 is adjusted to optimize the cooling rate of each portion of the workpiece 1 so that the positional variation in the cooling rate among each portions can be reduced to cool the workpiece 1 entirely homogeneously. In addition, since the workpiece 1 can be cooled homogeneously by mist, deformation and warpage of the workpiece 1 can be reduced significantly as shown in FIG. 7 so that the workpiece 1 can be manufactured with high dimensional accuracy.

After the carburizing and cooling, the workpiece 1 is finished at the finishing process (P4). For example, scales generated during the preceding processes are removed and the workpiece 1 is machined into a finish size. As described, according to the heat treating method of the preferred example, the workpiece 1 can be manufactured without deformation by cooling the workpiece 1 entirely homogeneously by mist. Since the deformation of the workpiece 1 is thus reduced, the finishing process may be omitted if it is not necessary. Otherwise, a at least machining allowance can be reduced in comparison with the conventional art so that a cost for the finishing work can be saved.

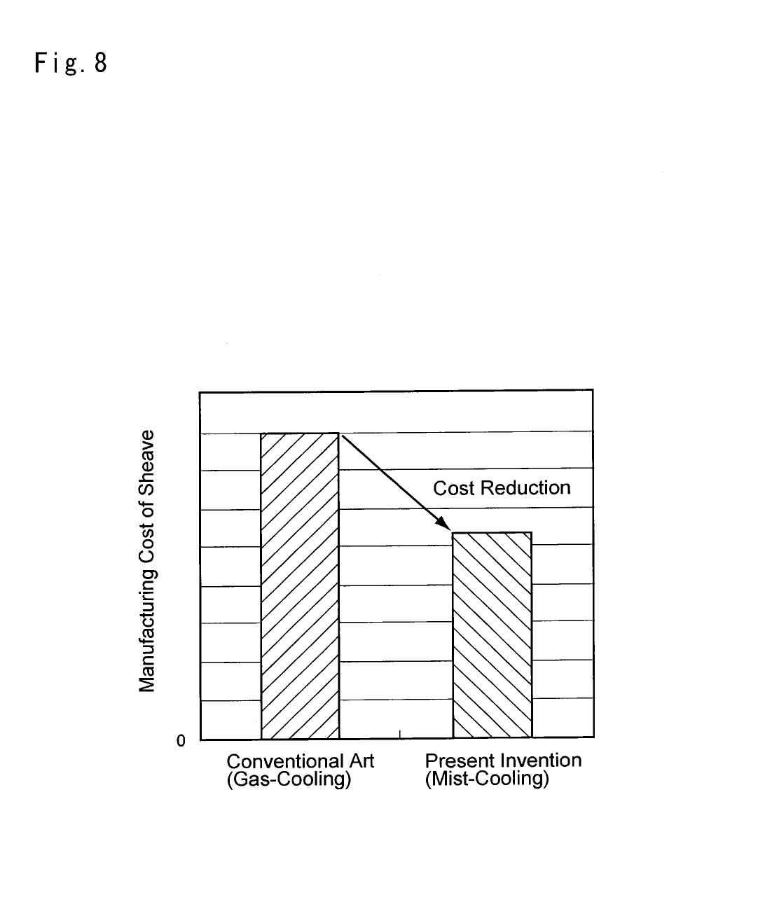

Such reduction in cost for manufacturing the workpiece 1 by the heat treating method of the preferred example is shown in FIG. 8. As can be seen from FIG. 8, the cost for manufacturing the workpiece 1 can be reduced significantly by manufacturing the workpiece 1 by the heat treating method of the present invention while cooling by mist, in comparison with that for manufacturing the workpiece 1 by the conventional method while cooling by gas.

Thus, according to the heat treating method and the heat treated metal article of the present invention, the cooling rate of the workpiece 1 can be optimized by adjusting the surface roughness of the workpiece 1. Specifically, the surface roughness of the portion of the workpiece 1 to which a large quantity of heat is distributed is reduced to be relatively finer to be cooled by the mist relatively faster. By contrast, the surface roughness of the portion of the workpiece 1 to which a small quantity of heat is distributed is increased to be relatively rougher to be cooled by the mist relatively slower. For this reason, the cooling rate of the workpiece 1 can be optimized without altering the positions, the number, and the spraying condition of the nozzles. That is, even if a size or configuration of the workpiece 1 is altered, the workpiece 1 can be cooled homogeneously by mist without altering the setting of the cooling facility. In addition, deformation of the workpiece 1 can be reduced by thus cooling the workpiece 1 homogeneously by mist. For this reason, the finishing work of the workpiece 1 can be omitted or simplified so that a cost for manufacturing the workpiece 1 can be reduced.

1. A method of heat treating metal articles, comprising:
a heating process of heating a metal workpiece under a predetermined heating condition;
a cooling process of cooling the workpiece by spraying mist of cooling water to the workpiece under a predetermined cooling condition after heating the workpiece; and
a surface treatment process of adjusting a surface roughness of the workpiece prior to the heating process in line with a thermal distribution in the workpiece heated during the heating process.

2. The method of heat treating metal articles as claimed in claim 1, wherein the surface treatment process includes a process of reducing the surface roughness of a portion of the workpiece to which a large quantity of heat is distributed.

3. The method of heat treating metal articles as claimed in claim 1, wherein an average diameter of the mist sprayed to the workpiece during the cooling process is adjusted within a range from 0.1 mm to 2.0 mm.

4. The method of heat treating metal articles as claimed in claim 1, wherein the workpiece includes a steel part of automobiles.

5. The method of heat treating metal articles as claimed in claim 4, wherein the workpiece includes a steel member of a pulley used in a belt-driven continuously variable transmission.

6. The method of heat treating metal articles as claimed in claim 1, wherein the surface treatment process includes a process of machining the workpiece.

7. The method of heat treating metal articles as claimed in claim 1, wherein the surface treatment process of the workpiece includes at least any of a shot-peening, a shot-blasting, a sand-blasting, a grinding and a polishing.

8. A heat treated metal article, that is heated under a predetermined heating condition, and then cooled by spraying mist of cooling water thereto under a predetermined cooling condition,
wherein a surface roughness of the metal article is adjusted in line with a thermal distribution in the metal article heated under a predetermined cooling condition, and thereafter the metal article is subjected to a heat treatment.

9. The heat treated metal article as claimed in claim 8, wherein the surface roughness of the metal article is reduced at a portion to which a large quantity of heat is distributed.

10. The heat treated metal article as claimed in claim 8, wherein the metal article includes a steel part of automobiles.

11. The heat treated metal article as claimed in claim 10, wherein the metal article includes a steel member of a pulley used in a belt-driven continuously variable transmission.
